(19) United States
(12) Patent Application Publication
(10) Pub. No.: US 2013/0254130 A1
(43) Pub. Date: Sep. 26, 2013

(54) Business method provides screening, authentication, and verification methods for conducting online business buy and sell

(71) Applicants: Jay J. Lin, Metuchen, NJ (US); Jeffrey H. Lin, Metuchen, NJ (US)

(72) Inventors: Jay J. Lin, Metuchen, NJ (US); Jeffrey H. Lin, Metuchen, NJ (US)

(21) Appl. No.: 13/348,007

(22) Filed: Mar. 21, 2012

(51) Int. Cl. G06Q 99/00

(52) U.S. Cl. 705/325

(57) ABSTRACT

The present invention provides Business methods to improve the internet based online business deal-matching and deal-making services, ecommerce websites information listing services, and other similar information services for Buyers, Sellers, Agents and Brokers in conducting business buys and sales by adding the process of screening, authentication, and verification as well as conducting the aforesaid process person in-person to maximize the value and protection of the services provided.

### INTRODUCTION

The present invention provides Business methods to improve the internet based online business deal-matching and deal-making services, ecommerce websites information listing services, and other similar information services for Buyers, Sellers, Agents and Brokers in conducting business buys and sales by adding the process of screening, authentication, and verification as well as conducting the aforesaid process person in-person to maximize the value and protection of the services provided.

### PRIOR ART

Many Residential/Commercial Real Estate Businesses have long been adopting the business methods of utilizing internet based online business services, ecommerce websites information listing services, and other similar information services for Buyers, Sellers, Agents and Brokers in conducting their buys and sales.

Many business buys and sells have also adopted the same internet and websites services method for a long period of time.

With the business methods of utilizing the availability of internet to improve the buy and sell service, many Residential/Commercial Real Estate Businesses have adopted and utilized a certain degree of screening, authentication, and verification process in conducting their business. The typical example could be seen such as the Real Estate Multiple listing Systems. (“MLS listing”)

However, none of the business buys and sells, outside of the Residential/Commercial Real Estate transaction Business, have adopted the screening, authentication, and verification process to improve the value of their services.

One of the business practices has adopted similar methods to the aforesaid screening, authentication, and verification process person in-person to maximize the value and protection of the services provided could be seen in U.S. Pat. No. 7,246,067 which involved a secure online dating support system and method requires potential members to submit personal information regarding themselves as a predicate to becoming a member of the dating system.

1. A method of screening, authentication, and verification (“SAV”) of information for online business to business, ecommerce websites and other similar services by person in-person to maximize the value and protection of the provided services.

2. The method of claim 1, further comprising SAV the qualified buyers.

3. The method of claim 1, where referring to person in-person conducting SAV comprises referring to person who shall possess a reasonable qualification.

4. The method of claim 1, where referring to conducting SAV of the information comprises referring to apply a professional or a reasonable standard.

5. The method of claim 3, where referring to person who shall possess a reasonable qualification comprises referring to a licensed attorney, a certified accountant, and other qualified professionals.

6. The method of claims 3 and 5, further comprising said person shall perform the entry, remove, update and sign off of the information listed.

7. The method of claims 3 and 5, further comprising said person may add comments with the information listed.

8. The method of claims 1, 3, and 5, further comprising rating the information listed.

9. The method of claims 1, 2, 3, and 5, further comprising whether or not the information listed are SAV or simply “S”, “A” or “V”.

10. The method of claims 1 and 2, further comprising selectively granting or restricting access to the listed information.

11. The method of claim 1, where referring to information comprises referring to ownership, number of employees, financial statements, licenses, tax returns, stock certificates, registration, and other normal documents possessed by a business owner.

12. The method of claim 6, further comprising hiding, withholding, omitting, blocking, pending, suspending, and special permitting the information listed.

13. The method of claim 12, further comprising applicable to claim 2.

14. The method of claim 1, further comprising to case of business sale by owner.

15. The method of claim 1, further comprising to case of franchise listing.

16. The method of claim 12, further comprising to designate the person in person in claim 1 as the contact person of the listing.

17. The method of claim 2, further comprising the person in person as the designated contact person of the qualified person.

18. The method of claim 1, further comprising an un-SAV information listed accessible to general users and viewers with an indication of un-SAV.

19. The method of claim 18, further comprising information provided by the third party.

20. The method of claims 18 and 19, further comprising applicable to claim 6.
